(19) United States
(12) Patent Application Publication
(10) Pub. No.: US 2024/0430110 A1
(43) Pub. Date: Dec. 26, 2024

(54) INFORMATION PROCESSING SYSTEM, NON-TRANSITORY COMPUTER READABLE MEDIUM, AND INFORMATION PROCESSING METHOD

(71) Applicant: FUJIFILM Buisiness Innovation Corp., Tokyo (JP)

(72) Inventor: Takashi MOMMA, Kanagawa (JP)

(73) Assignee: FUJIFILM Buisiness Innovation Corp., Tokyo (JP)

(21) Appl. No.: 18/519,505

(22) Filed: Nov. 27, 2023

(30) Foreign Application Priority Data
Jun. 23, 2023 (JP) 2023-103002

(51) Int. Cl. H04L 9/32; H04L 9/14

(52) U.S. Cl. CPC H04L 9/3297; H04L 9/14

(57) ABSTRACT

An information processing system includes: a processor configured to: in referring to pieces of key management information each including an authentication key and an application, the authentication key being included in authentication keys that are used for authentication by applications including the application that are installed in an information processing apparatus, each of the authentication keys being used when a corresponding one of the applications uses a service and being associated with the application using the authentication key, in response to presence of an authentication key of the authentication keys that is no longer associated with any one of the applications because an application of the applications that is associated with the authentication key is uninstalled from the information processing apparatus, delete the authentication key.

### CROSS-REFERENCE TO RELATED APPLICATIONS

This application is based on and claims priority under 35 USC 119 from Japanese Patent Application No. 2023-103002 filed Jun. 23, 2023.

### BACKGROUND

### (i) Technical Field

The present disclosure relates to an information processing system, a non-transitory computer readable medium, and an information processing method.

### (ii) Related Art

Recently, there is known technology for creating a service system on the cloud system to provide services via the Internet to apparatuses installed in an on-premise environment or the like. For such a service system, the use of technology for preventing impersonation by a fake device is known. By the technology, the authenticity of an apparatus is verified with authentication keys based on a public key cypher system, that is, a key pair with a public key and a private key. More specifically, the apparatus holds its private key, causes the cloud system to hold the public key of the apparatus, and relates the paired keys to each other. In executing a process in cooperation with the cloud system, an application running on the apparatus transmits, to the cloud system, an authentication request including the private key held by the apparatus. In response to a server that provides a cloud service on the cloud system receiving the authentication request including the private key, the server authenticates the apparatus that uses the private key. In response to success in the authentication by the server, the application is allowed to use the cloud service.

Examples of the related art include, for example, Japanese Unexamined Patent Application Publication (Translation of PCT application) No. 2008-502251 and Japanese Patent No. 3775791.

### SUMMARY

The life cycles of multiple applications installed in an information processing apparatus are not necessarily identical and are not necessarily be obtained as known information. Accordingly, if the multiple applications use the same authentication key at the time of authentication, time points when the authentication key is used are not known.

In recent years, the life cycle of an authentication key weighs, and a key no longer used at a certain point of time is required to be nullified or made inactive. It is desired to meet this requirement.

Aspects of non-limiting embodiments of the present disclosure relate to deleting an authentication key required by an application to use a service if the authentication key is no longer used.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing system including: a processor configured to: in referring to pieces of key management information each including an authentication key and an information application, the authentication key being included in authentication keys that are used for authentication by applications including the application that are installed in a processing apparatus, each of the authentication keys being used when a corresponding one of the applications uses a service and being associated with the application using the authentication key, in response to presence of an authentication key of the authentication keys that is no longer associated with any one of the applications because an application of the applications that is associated with the authentication key is uninstalled from the information processing apparatus, delete the authentication key.

### BRIEF DESCRIPTION OF THE DRAWINGS

Exemplary embodiments of the present disclosure will be described in detail based on the following figures, wherein:

FIG. 1 is a view illustrating the overall configuration of a service system in Exemplary Embodiment 1 and the configuration of the blocks of a multifunction printer (MFP);

FIG. 2 is a view illustrating an example data structure of key information stored in a key information memory in Exemplary Embodiment 1;

FIG. 3 is a flowchart illustrating a process in service use in Exemplary Embodiment 1;

FIG. 4 is a flowchart illustrating a private key management process in Exemplary Embodiment 1;

FIG. 5 is a view illustrating an example data structure of key information stored in the key information memory in Exemplary Embodiment 2;

FIG. 6 is a view illustrating example settings in a key management table after a new key algorithm provided by the authentication service is used from a key management table illustrated in FIG. 5;

FIG. 7 is a flowchart illustrating a private key management process in Exemplary Embodiment 2;

FIG. 8 is a view illustrating the overall configuration of a service system in Exemplary Embodiment 3 and the configuration of the blocks of the MFP; and

FIG. 9 is a flowchart illustrating a private key management process in Exemplary Embodiment 3.

### DETAILED DESCRIPTION

Hereinafter, exemplary embodiments of the present disclosure will be described on the basis of the drawings.

### Exemplary Embodiment 1

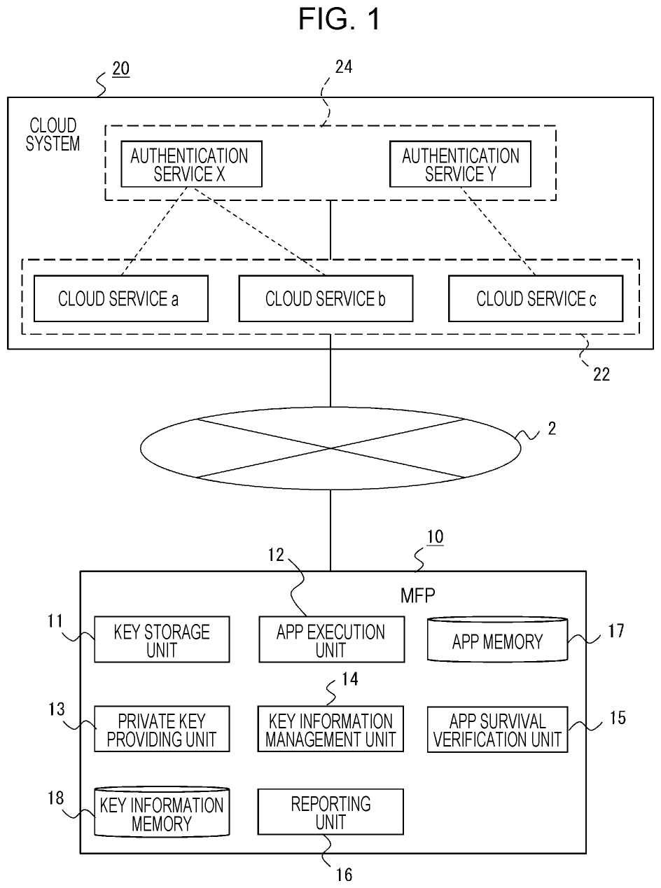

FIG. 1 is a view of the overall configuration of a service system in this exemplary embodiment. The service system in this exemplary embodiment is an exemplary embodiment of an information processing system according to the present disclosure. FIG. 1 illustrates a configuration in which a MFP 10 installed in an on-premise environment and a cloud system 20 are connected via a network 2 such as the Internet. The cloud system 20 includes a cloud service system 22 that provides predetermined cloud services a to c and an authentication service system 24 that provides authentication services X and Y using private keys. When not being discriminated from each other in the following description, the cloud services a to c are each referred to as a cloud service 22 collectively. When not being discriminated from each other, the authentication services X and Y are each referred to as an authentication service 24 collectively.

The cloud system 20 illustrated in FIG. 1 provides the three cloud services a to c and the two authentication services X and Y; however, the numbers of provided services do not have to be these numbers and may be 1 or more.

The cloud service 22 is provided by one service server serving as an exemplary embodiment of an information processing apparatus or by multiple service servers cooperating with each other. In contrast, one service server provides one or more cloud services 22. Typically, one cloud service 22 is provided by one service server.

Like the cloud service 22, the authentication service 24 is provided by one or more service servers serving as an exemplary embodiment of the information processing apparatus. One service server also provides one or more authentication services 24. Typically, one authentication service 24 is provided by one service server.

The service servers providing the services 22 and 24 are each a virtual server computer formed on the cloud system 20. Despite the virtual machine, each service server has a CPU, a ROM, a RAM, a memory, and a communication unit. The cloud services 22 and the authentication services 24 basically provide the same services as existing services.

The MFP 10 in this exemplary embodiment serves as an exemplary embodiment of an image forming apparatus having various functions such as a printing function, a copying function, and a scanning function and is an apparatus having the information processing apparatus (also referred to as a computer) built therein. The MFP 10 in this exemplary embodiment may be implemented by a configuration of existing general-purpose hardware. The MFP 10 thus includes, a CPU, a ROM, a RAM, a memory such as a hard disk drive (HDD) that stores image data, a confidential box, and the like, an operation panel serving as a user interface, a network interface that connects to the network 2 such as the Internet, a scanner and a print engine that are required to provide various functions, and the like.

The MFP 10 in this exemplary embodiment also includes, as a unit that stores a key, a hardware security module (HSM) such as a trusted platform module (TPM). The HSM is an enhanced tamper-resistant hardware device that keeps an encryption process secure by generating, protecting, and managing keys used for encrypting and decrypting data and for generating a digital signature and a certificate. The HSM is fixed on the substrate. The service system in this exemplary embodiment is usable by multiple MFPs 10. However, FIG. 1 thus illustrates only one MFP 10 because each MFP 10 has the same functions (described later).

FIG. 1 further illustrates example functional blocks of the MFP 10 in this exemplary embodiment. The MFP 10 in this exemplary embodiment has a key storage unit 11, an app execution unit 12, a private key providing unit 13, a key information management unit 14, an app survival verification unit 15, a reporting unit 16, an app memory 17, and a key information memory 18. The MFP 10 naturally provides multiple functions such as the printing function and the scanning function; however, functional blocks not used for the description are omitted from FIG. 1 in this exemplary embodiment.

The key storage unit 11 is implemented by the HSM described above and stores at least a private key. For verification of its authenticity, the MFP 10 generates a key pair with a public key and a private key based on the public key cypher system as a pair of pieces of information enabling pairing to be proved. The private key is held by the key storage unit 11 as described above. In contrast, the public key is held by the authentication service system 24.

The authentication key denotes a key used for authentication. The private key and the public key are generated as a key pair and used in pairs. Accordingly, the authentication key referred to in this exemplary embodiment corresponds to the key pair described above in a broad sense and also denotes a private key used by the MFP 10 for authentication in a narrow sense.

The app execution unit 12 runs an application in an executable state resulting from the installation of the application on the MFP 10. Before starting using one of the cloud services 22, the application transmits an authentication request including the private key stored in the key storage unit 11 to the cloud service 22. In response to an acquisition request for the private key from the application, the private key providing unit 13 provides the private key to the application having requested the acquisition.

The key information memory 18 stores key information (described later), while the key information management unit 14 manages registration, update, deletion, and the like of the key information. The app survival verification unit 15 verifies the survival of the application set in the key information. The term “survival” denotes that an application is in an executable state resulting from the installation of the application on the MFP 10. In contrast, the phrase “not survive” denotes that the application is not in the executable state because of uninstallation or the like from the MFP 10.

The reporting unit 16 reports the deletion or the like of the private key to the administrator or the like for the MFP 10 (described in detail later). The app memory 17 stores surviving applications. Strictly speaking, an application is loaded in the RAM and thereby becomes executable; however, in this exemplary embodiment, as long as the application is stored in the app memory 17, the application is recognized to be in the executable state, that is, as surviving.

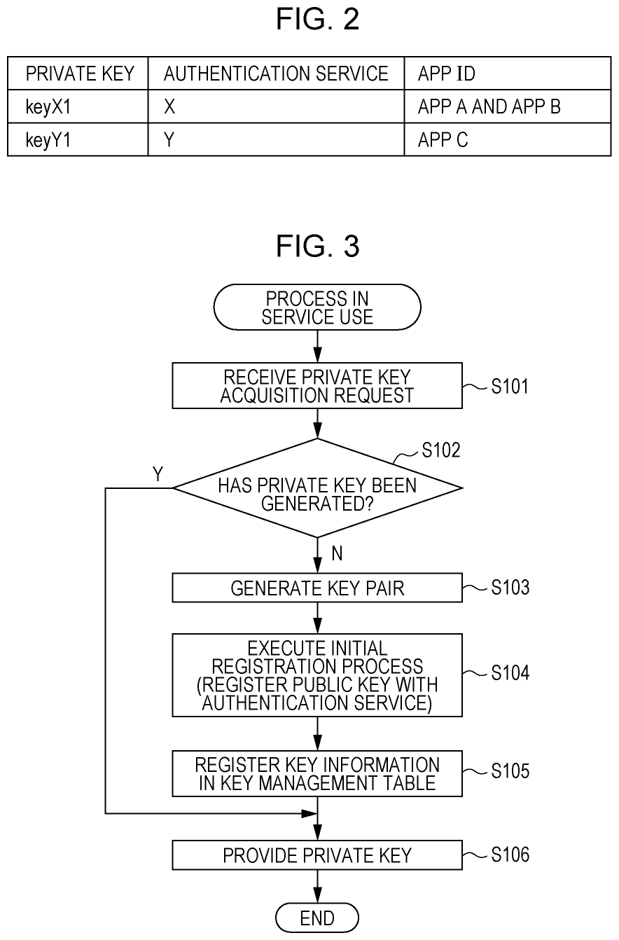

FIG. 2 is a view illustrating an example data structure of the key information stored in the key information memory 18 in this exemplary embodiment. As illustrated in FIG. 2, the key information is expressible in a table. Accordingly, in the following description, the key information and a key management table both correspond to key management information; however, the description is provided on the assumption that pieces of key information each associated with a corresponding one of private keys are managed by using the key management table.

The key information is set in such a manner that an authentication service and an app ID are associated with an identification of a private key (hereinafter, referred to as a key ID). For the authentication service, the identification of the authentication service 24 is set as an authentication destination information element identifying an authentication destination in which authentication using a private key is performed. The identification of the authentication service 24 is X or Y according to the example illustrated in FIG. 2. As the app ID, the identification of the application using the private key as the authentication key in the authentication service 24 is set.

It is understood that in the example settings of the key information illustrated in FIG. 2, the private key with the key ID “keyX1” is used for authentication performed by applications that are an app A and an app B for the authentication service X. Accordingly, a public key to be paired with the private key “keyX1” is required to be held and managed in relation to the authentication service X. Likewise, it is understood that a private key with the key ID “keyY1” is used for authentication performed by an application that is an app C for the authentication service Y. Accordingly, a public key to be paired with the private key “keyY1” is required to be held and managed in relation to the authentication service Y.

The components 11 to 16 of the MFP 10 are each implemented by cooperative operations of a computer included in the MFP 10 and programs run by a CPU included in the computer. The memories 17 and 18 are implemented by a HDD included in the MFP 10. Alternatively, a RAM or an external memory may be used via a network.

The programs used in this exemplary embodiment may be provided not only through a communication medium but also in such a manner as to be stored in a computer readable recording medium such as a USB memory. Various processes are executed in such a manner that the programs provided from the recording medium or the communication medium are installed on the computer and that the CPU of the computer serially runs the programs.

Operations in this exemplary embodiment will then be described. First, a process executed when an application uses the cloud service 22 will be described by using a flowchart illustrated in FIG. 3.

Each application in this exemplary embodiment is an application for providing a user with the cloud service 22 in cooperation with a predetermined one of the cloud services 22. The cloud service 22 requests the authentication service 24 to authenticate the MFP 10, and the authentication service 24 to be requested is decided according to a contract. The administrator for the MFP 10 thus knows the cloud service 22 to operate in cooperation with a corresponding one of the applications and the authentication service 24 to be used for the authentication of the MFP 10, and thus the application has recognized the cloud service 22 and the authentication service 24 to be used.

In response to the start of the application, the app execution unit 12 starts running the application. The application first makes an acquisition request to the private key providing unit 13 for a private key required for the use of the cloud service 22. This acquisition request includes its app ID and the authentication service 24 to be used.

After receiving the acquisition request transmitted from the app execution unit 12 (step S101), the private key providing unit 13 verifies whether key information composed of a pair of the app ID included in the acquisition request and the authentication service 24 has been registered in the key management table. The registering of the key information means that the private key associated with the authentication service has been generated and is present (Y in step S102). The private key providing unit 13 thus refers to the key information, identifies a private key associated with the pair of the app ID and the authentication service 24, takes out the private key from the key storage unit 11, and provides the private key to the application having requested the acquisition (step S106).

In contrast, the registering not performed of the key information leads to a determination that the key pair related to the authentication service 24 has not been generated. In this case (N in step S102), the key information management unit 14 generates the key pair (step S103) and executes an initial registration process (step S104).

The authentication service 24 has assigned the administrator for the MFP 10 authentication information composed of an ID and a password or a customer code at the time of concluding the contract. Accordingly, the key information management unit 14, for example, prompts the administrator to input and set the authentication information or the customer code from the operation panel in the initial registration process to be authenticated as a valid administrator and a valid MFP 10. The MFP 10 needs to access the authentication service 24, and thus a URL from which an access destination, that is, an authentication destination is identifiable may be designated as the identification of the authentication service 24 in the acquisition request from the app. In this case, the reference “X” or “Y” corresponding to the identification of the authentication service 24 is conveniently set as the authentication destination information element to be included in the key information in the key management table illustrated in FIG. 2, but a URL may be set.

If the authentication of the administrator succeeds, the key information management unit 14 stores the private key of the generated key pair in the key storage unit 11. In contrast, a public key paired with the stored private key is transmitted to the authentication service 24 and is registered.

As described above, the key information management unit 14 generates the key information in such a manner as to associate the key ID of the generated private key with the authentication service 24 and the app ID that are included in the acquisition request and registers the key information in the key management table (step S105). Thereafter, the private key providing unit 13 refers to the key information and takes out, from the key storage unit 11, the private key associated with the authentication service 24 and the app ID that are included in the acquisition request and provides the private key to the application having requested the acquisition (step S106).

As described above, after acquiring the private key in response to the private key acquisition request made to start using the cloud service 22, the application makes a request to the cloud service 22 for the use of the service in such a manner as to add a digital signature using the private key to the request.

If the application having made the acquisition request is the app A, the app A transmits the acquisition request to the private key providing unit 13 with the authentication service X being designated. In this case, according to the example settings in the key management table illustrated in FIG. 2, the private key providing unit 13 provides the private key “keyX1”. If the application having made the acquisition request is the app C, the app C transmits the acquisition request to the private key providing unit 13 with the authentication service Y being designated. In this case, according to the example settings in the key management table illustrated in FIG. 2, the private key providing unit 13 provides the private key “keyY1”.

If key information associated with the private key “keyY1” has not been registered in the key management table when the acquisition request from the app C is received, the key information management unit 14 generates a key pair including the private key “keyY1”, executes the initial registration process described above, and registers the key information including the private key “keyY1” in the key management table.

If the use of the service is requested from the MFP 10, the cloud service 22 requests the authentication service 24 for authentication using the private key included in the service use request. If the authentication of the application and thus the MFP 10 succeeds, the cloud service 22 thereby starts the use in response to the request from the application. The application is thus allowed to use the cloud service 22.

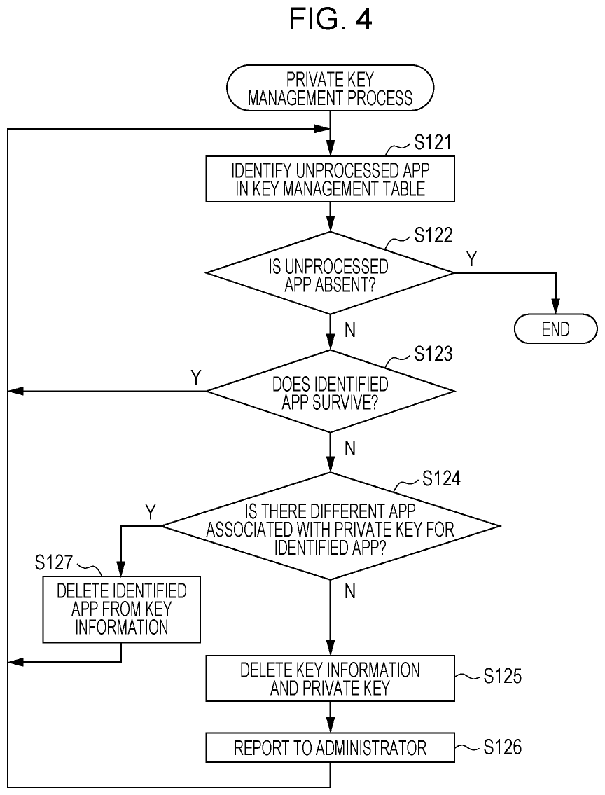

As described above, the private key is required when the application uses the cloud service 22. Accordingly, if the private key is likely to be used by the application, the private key is required to be managed in the key management table and also to be stored in the key storage unit 11. In contrast, after the private key is no longer used by any of the applications, the private key is not required. Accordingly, it is not preferable to use the unnecessary private key from the viewpoint of security. The private key is thus desirably deleted. A private key management process in this exemplary embodiment in which the private key as described above is held or deleted will be described by using a flowchart illustrated in FIG. 4.

The private key management process is executed at predetermined timing. For example, the private key management process may be executed when the MFP 10 is started or may be executed as a scheduled process after the MFP 10 is started.

In response to the start of a program for the private key management process, the app survival verification unit 15 verifies the survival of the applications registered in the key management table for each application. For the verification, the app survival verification unit 15 identifies one of unprocessed application in the key management table (step S121). If an unprocessed application is absent (Y in step S122), the process is terminated.

If an unprocessed application is present after reference to the app ID item in the key management table is made (N in step S122), the app survival verification unit 15 verifies the survival of the identified application. Specifically, the app survival verification unit 15 searches the app memory 17. If the application has been deleted because of uninstallation or the like, the app survival verification unit 15 determines that the application does not survive. If the application is stored without being deleted, the app survival verification unit 15 determines that the application survives.

If the survival of the application is verified (Y in step S123), the private key registered in the key management table in association with the application is likely to be still used. Accordingly, in this case, the process returns to step S121 and moves to a next unprocessed application.

In contrast, if the survival of the application is not verified (N in step S123), the app survival verification unit 15 verifies whether a different application is set in the key information associated with the application. If a different application is set in the key information (Y in step S124), the app survival verification unit 15 instructs the key information management unit 14 to delete the app ID of the application serving as a processing target from the key information because an acquisition request made from the different application leads to reference to the key information. The key information management unit 14 deletes the app ID in accordance with the instruction (step S127).

In contrast, if there is no application except the application serving as the processing target in the key information associated with the application (N in step S124), the private key managed in the key information may be determined as being no longer used by any of the applications. The app survival verification unit 15 thus instructs the key information management unit 14 to delete the key information. The key information management unit 14 deletes not only the key information in accordance with the instruction but also the private key stored in the key storage unit 11 (step S125).

As described above, if the private key and the key information including the private key are deleted, the reporting unit 16 reports, to the administrator or the like for the MFP 10, that the private key is deleted in accordance with the instruction from the key information management unit 14 (step S126). This enables the administrator to know that the reported private key is deleted.

According to the example settings in the key management table illustrated in FIG. 2, if the key management process above is executed after the app A is uninstalled, the key information including the private key “keyX1” is not deleted because the private key “keyX1” used by the app A is likely to be still used by the app B. In contrast, if the key management process above is executed after the app C is uninstalled, no application is associated with the private key “keyY1” used by the app C because the association with the app C is cancelled, and thus the key information including the private key “keyY1” is deleted.

This exemplary embodiment enables a private key that is no longer used by an application to be deleted quickly as described above. To delete the private key quickly, the private key management process described above may be executed at relatively short intervals. The interval for executing the private key management process may be decided on the basis of actual operations.

### Exemplary Embodiment 2

As described for Exemplary Embodiment 1 above, a key pair composed of a private key and a public key is a pair of pieces of information enabling pairing to be proved. A key pair based on a new cypher system with enhanced security has also been developed. This exemplary embodiment further focuses on the cypher system of the authentication key as compared with Exemplary Embodiment 1 above.

The system configuration in this exemplary embodiment and the configuration of the blocks of the MFP 10 may be the same as those in Exemplary Embodiment 1 illustrated in FIG. 1. In this exemplary embodiment, the data structure of the key information is different from that in Exemplary Embodiment 1.

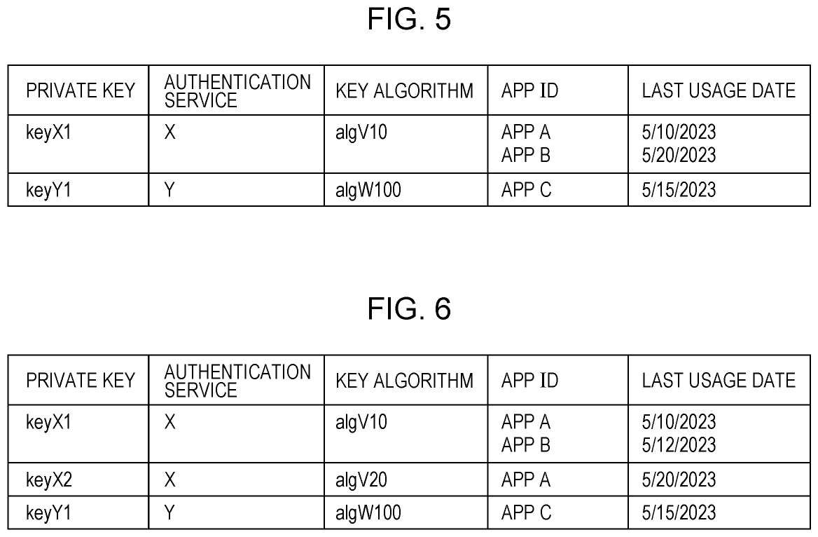

FIG. 5 is a view illustrating an example data structure of the key information stored in the key information memory 18 in this exemplary embodiment. As illustrated in FIG. 5, in the key information in this exemplary embodiment, a key algorithm serving as a cypher system information element and the last usage date serving as a last usage date information element are further set in Exemplary Embodiment 1 in association with each other. As the key algorithm, an algorithm name that enables a cypher system employed for a private key to be identified is set. The last usage date is associated with an application on a per application basis and is information indicating a date when the private key is used by the application most recently. Such detailed information that identifies the usage date and time of the private key by hours and minutes is regarded as unnecessary, and thus the last usage date information element is managed on a daily basis in this exemplary embodiment.

Operations in this exemplary embodiment will subsequently be described. The process in service use is basically the same as that in Exemplary Embodiment 1. However, this exemplary embodiment is different in that an acquisition request for a private key from an application further includes a key algorithm. Involved with the difference, the application includes an app ID, authentication destination information element and a key algorithm in the acquisition request for the private key. The private key providing unit 13 refers to the key management table illustrated in FIG. 5 and then provides the app ID included in the acquisition request, the authentication destination information element, and the private key associated with the key algorithm, while the key information management unit 14 updates the last usage date associated with the authentication destination information element, the key algorithm, and the app ID that are included in the acquisition request, on the basis of the date information at the time when the acquisition request is acquired.

Like Exemplary Embodiment 1, in starting using the cloud service 22, the application makes a request to the cloud service 22 for the use of the service in such a manner as to add a digital signature using the private key acquired in response to the acquisition request.

Suppose a case where the application having made the acquisition request is the app A. If the app A transmits an acquisition request including the authentication service X and the key algorithm “algV10”, the private key providing unit 13 provides the private key “keyX1” with reference to the key management table illustrated in FIG. 5.

Subsequently, the app A performs a digital signature by using the private key “keyX1” and makes a request for the cloud service a with the digital signature added to the request. Like Exemplary Embodiment 1, the authentication service X verifies the authenticity of the MFP 10 by using the digital signature received from the cloud service a and a held public key. If the authentication succeeds, the authentication service X transmits the authentication result to the cloud service a. If the use of the key algorithm “algV20” that is a new algorithm is started in the authentication service X, the authentication service X also transmits a warning message recommending change to the new key algorithm. If the authentication service X is in a period of transition to the new key algorithm, the authentication service X transmits the warning message as described above, permits the use of the key algorithm “algV10”, and ends up with authentication success.

The cloud service a starts providing a service in response to the authentication success and transmits, to the app A, the warning message together with a report of the authentication success.

In response to receiving the warning message, the app A verifies whether the app A is capable of processing the key algorithm “algV20”. If the app A is capable, the app A may include the key algorithm “algV20” in a next acquisition request for a private key. If the app A is not capable and is in a key algorithm transition period, the app A uses the key algorithm “algV10” and is expected to be upgraded to be capable of processing the key algorithm “algV20”. To achieve this, the reporting unit 16 may display an indication on the operation panel in response to the app A receiving the warning message, the indication representing that the key algorithm to be used in the authentication service X has been changed. The reporting unit 16 may also report the change to the administrator for the MFP 10 by e-mail. The administrator having received the report preferably plans to upgrade the app A in the transition period.

When the private key providing unit 13 acquires the acquisition request including the key algorithm “algV20”, the key information associated with the key algorithm “algV20” has not been generated. The key information management unit 14 thus generates a key pair as described for Exemplary Embodiment 1 by using FIG. 3, generates key information in such a manner as to associate the authentication service X, the key algorithm “algV20”, the app A. and the last usage date with the generated private key “keyX2”, and registers the key information in the key management table. FIG. 6 illustrates example settings in the key management table after the registration.

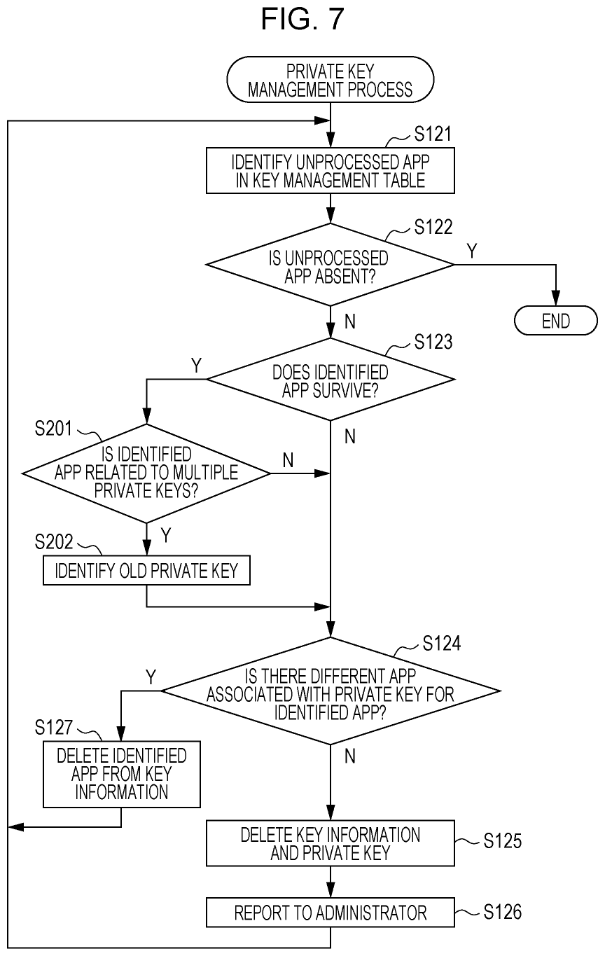

Hereinafter, a private key management process in this exemplary embodiment will be described by using a flowchart illustrated in FIG. 7. The same steps as those in Exemplary Embodiment 1 are denoted by the same step numbers, and description thereof is appropriately omitted.

According to the example settings of the key information in FIG. 6, this exemplary embodiment is different from Exemplary Embodiment 1 in that the multiple private keys “keyX1” and “keyX2” are associated with the authentication service X and that the same app A is associated with each of the multiple private keys “keyX1” and “keyX2”. Steps based on these differences will be described for this exemplary embodiment.

The description is provided focused on the app A. If the survival of the app A is verified (Y in step S123), and if the app A is related to the only one private key as illustrated in FIG. 5 (N in step S201), the process may move to step S124 to continue in the same manner as in Exemplary Embodiment 1.

If the app A is related to the multiple private keys “keyX1” and “keyX2” like the example settings in the key management table illustrated in FIG. 6 (Y in step S201), the key information management unit 14 identifies, for the app A, the newest private key of the multiple authentication keys with reference to each last usage date of a corresponding one of the multiple private keys. In other words, the key information management unit 14 identifies one or more old private keys other than the newest private key (step S202). The process may then be continued in the same manner as in Exemplary Embodiment 1.

According to the example settings in the key management table illustrated in FIG. 6, the private key “keyX1” is identifiable as a private key older than the private key “keyX2”. Since the app B is still related to the private key “keyX1”, the key information management unit 14 only deletes the app A from the key information including the private key “keyX1” and does not delete the key information itself (in step S124 Y, S127).

In this exemplary embodiment, a private key associated with an older one of the last usage dates for the same application is regarded as an old private key. Although the app A is related to the private keys “keyX1” and “keyX2” as described above, the older private key “keyX1” is regarded, from the viewpoint of security, as not being used retroactively, and thus the app ID of the application is deleted from the key information associated with the private key other than newest one.

Nevertheless, the use of an old private key is permitted in the key algorithm transition period, and thus there is logically a possibility that the old private key is used. How old the private key is (the age of the private key) and how old the date when the application uses the private key last time do not necessarily match at any time, and thus there arises a possibility that the age of the private key is not determined correctly from the last usage date included in the key information.

Hence, a date when the private key is registered for the first time in the key management table may be set as a registration date information element in the key information including the private key in association with the key information. The age of the private key may thereby be determined with reference to the registration date information element, instead of the last date of usage by the application described above.

Nevertheless, in the key algorithm transition period, the age of the key algorithm and the age of the private key do not necessarily match at any time. This is because it is assumable that when an application not associated with the private key “keyX2” uses the authentication service X for the first time, the application uses the private key “keyX1”. However, on the assumption that the ages match from actual operations of the private key, the age of the key algorithm is determined by using information acquirable in the MFP 10. If information enabling the start date of using the key algorithm is acquirable from the authentication service 24, the registration date information element may be set on the basis of the information.

The key information management unit 14 may also delete a private key with a predetermined time elapsed since the registration in the key management table. The predetermined time may be set on the basis of, for example, the key algorithm transition period.

Automatically deleting the private key with the elapse of the predetermined time may lead to promotion of transition to authentication using a new key algorithm. For example, according to the example settings in the key management table illustrated in FIG. 6, there is a possibility that the key information associated with the old private key “keyX1” is forced to be deleted. This causes the app B not to be authenticated by the authentication service X.

Suppose a case where the app B is not associated with the key algorithm “algV20”. In the key algorithm transition period, in response to the app B designating the private key “keyX1” in the acquisition request, the key information management unit 14 generates key information in such a manner as to execute the initial registration process and thereby regenerates the private key associated with the key algorithm “algV10”. This enables the app B to be authenticated by the authentication service X in the transition period. In this case, the reporting unit 16 may report, to the administrator, that an acquisition request including the old key algorithm is made.

After the key algorithm transition period, it is not possible for the app B to be authenticated by the authentication service X. In this case, the app B needs to be upgraded to support the new key algorithm “algV20”. The app B is expected to be upgraded within the transition period by the administrator.

### Exemplary Embodiment 3

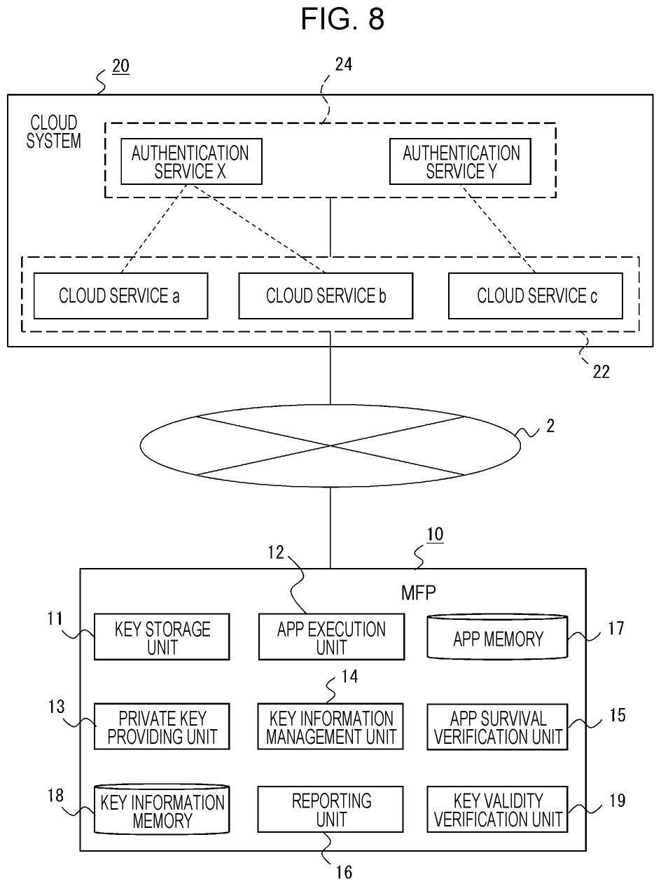

FIG. 8 is a view of the overall configuration of a service system in this exemplary embodiment. The service system in this exemplary embodiment has a configuration in which a key validity verification unit 19 is added to the MFP 10 in Exemplary Embodiment 1. Suppose a case where the authentication service 24 serving as an application authentication destination authenticates an application by verifying that a private key transmitted to the cloud service 22 when the application uses the cloud service 22 is paired with a held public key. In this case, the key validity verification unit 19 verifies the validity of the key pair before a deletion target private key is deleted. The key validity verification unit 19 is implemented by cooperative operations of the computer included in the MFP 10 and the programs run by the CPU included in the computer.

As described for the exemplary embodiments, if a private key is no longer used by an application, or if the predetermined has elapsed since the use of a key algorithm is started, the private key is automatically deleted. If the application associated with the private key deleted automatically survives, but if the key information management unit 14 newly generates a key pair in response to an acquisition request for the private key from the application and thus executes the initial registration process, the application may be authenticated by the authentication service 24.

However, to enable the application to be authenticated by the authentication service 24, the initial registration process including the registration or the like of the public key with the authentication service 24 needs to be executed as described above. If the authentication using the public key held and managed by the authentication service 24 is still valid, it is considered that even if the private key paired with the public key is no longer used by any application, the trouble to delete the private key does not have to be taken for the future reuse. This eliminates the need to execute the initial registration process involved with the deletion of the private key.

Hence, in this exemplary embodiment, the key validity verification unit 19 is provided. If a private key is to be deleted, the key validity verification unit 19 verifies whether to perform authentication using the private key before the private key is deleted.

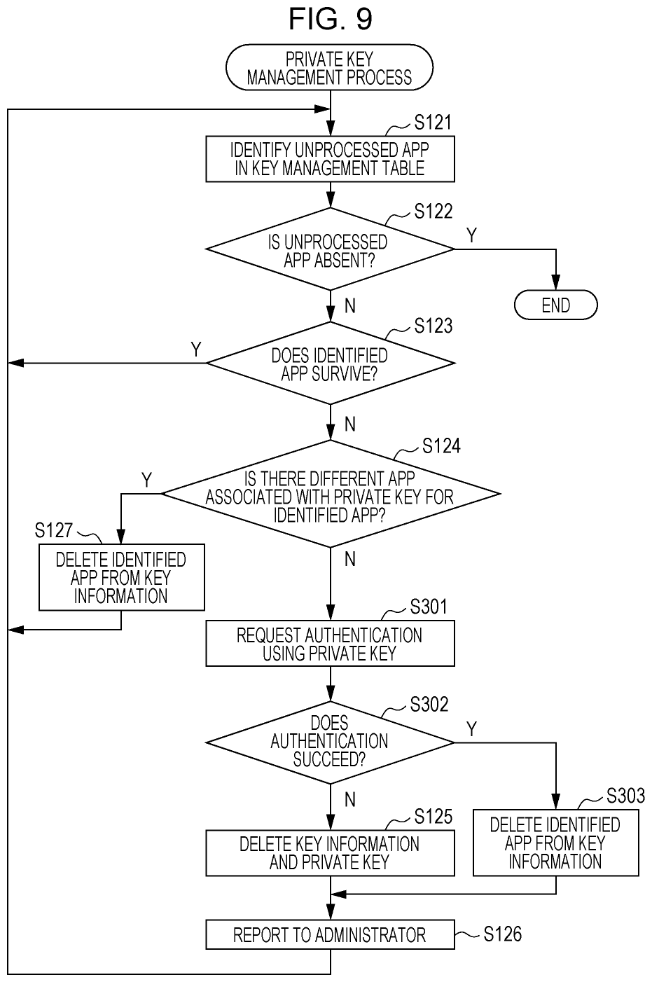

Operations in this exemplary embodiment will then be described. The process in service use is basically the same as that in Exemplary Embodiment 1. The content of a private key management process in this exemplary embodiment is slightly different from those in Exemplary Embodiments 1 and 2. Hereinafter, the private key management process in this exemplary embodiment will be described by using a flowchart illustrated in FIG. 9. The same steps as those in Exemplary Embodiment 1 are denoted by the same step numbers, and description thereof is appropriately omitted. The description herein provided by using the key management table illustrated in FIG. 2.

For example, the app C is uninstalled before the private key management process is executed. According to the example settings in the key management table illustrated in FIG. 2, an application other than the app C is not related to the private key “keyY1” associated with the app C (step S121, N in step S122, N in step S123, and N in step S124). In Exemplary Embodiment 1, the private key “keyY1” is thus deleted in step S125.

In this exemplary embodiment, the validity of the key pair is verified before the private key “keyY1” is deleted. That is, the key validity verification unit 19 transmits the private key “keyY1” to the authentication service Y identifiable from the key information and thereby requests authentication using the private key “keyY1” (step S301).

The authentication service Y tries the authentication using the transmitted private key “keyY1”. If the authentication service Y still holds the public key paired with the private key “keyY1”, the authentication succeeds. If the authentication service Y no longer holds the public key, the authentication fails. For example, it is considered that the authentication service Y holds the public key if the authentication is tried in a period of a contract for the MFP 10. The authentication service Y returns a result of the authentication performed in response to the authentication request from the key validity verification unit 19.

If the authentication result is returned from the authentication service Y in response to the authentication request, the key information management unit 14 performs processing in the following manner. If the authentication succeeds (Y in step S302), the key information management unit 14 determines that the authentication using the private key “keyY1” is still valid and deletes the application, that is, the app C in this example, from the key information including the private key “keyY1” (step S303). The key information including the private key “keyY1” is thereby held in a state where the app ID data item is blank without being deleted from the key management table. If the private key providing unit 13 receives, from one of the applications in this state, the private key acquisition request with the authentication service Y designated, the private key “keyY1” related to the authentication service Y may be provided to the application having requested the acquisition without the initial registration process being executed.

In contrast, if the authentication fails (N in step S302), the key information management unit 14 determines that the authentication using the private key “keyY1” is nullified. The key information management unit 14 thus deletes the key information including the private key “keyY1” determined as deletable but held without being deleted and also deletes the private key “keyY1” held by the key storage unit 11 (step S125).

The reporting unit 16 reports the result of the process executed by the key information management unit 14 to the administrator or the like for the MFP 10 (step S126).

According to this exemplary embodiment, whether to actually delete the deletion target private key as described above may be determined in consideration for the validity of the private key.

The exemplary embodiments may be implemented appropriately in combination with each other.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
a processor configured to:
   in referring to pieces of key management information each including an authentication key and an application, the authentication key being included in authentication keys that are used for authentication by applications including the application that are installed in an information processing apparatus, each of the authentication keys being used when a corresponding one of the applications uses a service and being associated with the application using the authentication key, in response to presence of an authentication key of the authentication keys that is no longer associated with any one of the applications because an application of the applications that is associated with the authentication key is uninstalled from the information processing apparatus, delete the authentication key.
      (((2)))

In the information processing system according to (((1))),
in each piece of key management information, an authentication destination information element, a cypher system information element, an application identification, and a last usage date information element are set in association with the authentication key, the authentication destination information element being included in authentication destination information elements that each identify a corresponding one of authentication destinations for a corresponding one of the applications that uses one of the authentication keys, the cypher system information element being included in cypher system information elements for the respective authentication keys, the application identification being included in application identifications and being assigned to the application that uses the authentication key, the last usage date information element being included in last usage date information elements that each indicate a date when the application uses the authentication key last time, and
the processor is configured to:
   in response to an acquisition request for the authentication key from the application that uses the authentication key including an authentication destination information element of the authentication destination information elements that is for the authentication key and a cypher system information element of the cypher system information elements that is for the authentication key, make an update to a last usage date information element of the last usage date information elements that is associated with the authentication destination information element, the cypher system information element, and the application identification of the application, the update being made on a basis of a piece of date information regarding time when the acquisition request is acquired; and
   in response to more than one authentication keys of the authentication keys being associated with one authentication destination information element of the authentication destination information elements in referring to the pieces of key management information, refer to, among the last usage date information elements, last usage date information elements each associated with a corresponding one of the more than one authentication keys and identify a newest authentication key of the more than one authentication keys.
      (((3)))

In the information processing system according to (((2))),
the processor is configured to:
   in response to one application identification of the application identifications being associated with at least two authentication keys included in the more than one authentication keys associated with the one authentication destination information element, refer to, among the last usage date information elements, last usage date information elements that are associated with the one application identification and delete an authentication key that is included in the at least two authentication keys associated with the one application identification and that is not the newest authentication key.
      (((4)))

In the information processing system according to any one of (((1))) to (((3))),
a registration date information element is associated with the authentication key in each piece of key management information, the registration date information element being included in registration date information elements that each indicate a date when a corresponding one of the authentication keys is registered with the piece of key management information, and
the processor is configured to: refer to the registration date information elements; and delete, from the authentication keys, an authentication key with a predetermined time elapsed since the authentication key is registered.
   (((5)))

In the information processing system according to any one of (((1))) to (((4))),
in authenticating the application using the service by an authentication destination for the application, the authenticating being performed by verifying that an authentication key that is transmitted when the application uses the service and that is one of a pair of keys is paired with a held different one of the pair of keys, and
the processor is configured to: verify validity of the pair of keys by transmitting an authentication key to be deleted to the authentication destination before the authentication key to be deleted is deleted.
   (((6)

In the information processing system according to (((5))),
the processor is configured to: in response to verifying that the pair of keys are valid, hold the authentication key to be deleted without deleting the authentication key to be deleted.
   (((7)))

In the information processing system according to (((5))),
the processor is configured to: in response to verifying that the pair of keys are not valid, delete the authentication key determined as deletable.
   (((8)))

A program causes a computer to execute a process including:
in referring to pieces of key management information each including an authentication key and an application, the authentication key being included in authentication keys that are used for authentication by applications including the application that are installed in an information processing apparatus, each of the authentication keys being used when a corresponding one of the applications uses a service and being associated with the application using the authentication key, in response to presence of an authentication key of the authentication keys that is no longer associated with any one of the applications because an application of the applications that is associated with the authentication key is uninstalled from the information processing apparatus, deleting the authentication key.

What is claimed is:

1. An information processing system comprising:
a processor configured to:
in referring to pieces of key management information each including an authentication key and an application, the authentication key being included in authentication keys that are used for authentication by applications including the application that are installed in an information processing apparatus, each of the authentication keys being used when a corresponding one of the applications uses a service and being associated with the application using the authentication key, in response to presence of an authentication key of the authentication keys that is no longer associated with any one of the applications because an application of the applications that is associated with the authentication key is uninstalled from the information processing apparatus, delete the authentication key.

2. The information processing system according to claim 1,
wherein in each piece of key management information, an authentication destination information element, a cypher system information element, an application identification, and a last usage date information element are set in association with the authentication key, the authentication destination information element being included in authentication destination information elements that each identify a corresponding one of authentication destinations for a corresponding one of the applications that uses one of the authentication keys, the cypher system information element being included in cypher system information elements for the respective authentication keys, the application identification being included in application identifications and being assigned to the application that uses the authentication key, the last usage date information element being included in last usage date information elements that each indicate a date when the application uses the authentication key last time, and
wherein the processor is configured to:
in response to an acquisition request for the authentication key from the application that uses the authentication key including an authentication destination information element of the authentication destination information elements that is for the authentication key and a cypher system information element of the cypher system information elements that is for the authentication key, make an update to a last usage date information element of the last usage date information elements that is associated with the authentication destination information element, the cypher system information element, and the application identification of the application, the update being made on a basis of a piece of date information regarding time when the acquisition request is acquired; and
in response to more than one authentication keys of the authentication keys being associated with one authentication destination information element of the authentication destination information elements in referring to the pieces of key management information, refer to, among the last usage date information elements, last usage date information elements each associated with a corresponding one of the more than one authentication keys and identify a newest authentication key of the more than one authentication keys.

3. The information processing system according to claim 2,
wherein the processor is configured to:
in response to one application identification of the application identifications being associated with at least two authentication keys included in the more than one authentication keys associated with the one authentication destination information element, refer to, among the last usage date information elements, last usage date information elements that are associated with the one application identification and delete an authentication key that is included in the at least two authentication keys associated with the one application identification and that is not the newest authentication key.

4. The information processing system according to claim 1,
wherein a registration date information element is associated with the authentication key in each piece of key management information, the registration date information element being included in registration date information elements that each indicate a date when a corresponding one of the authentication keys is registered with the piece of key management information, and
wherein the processor is configured to: refer to the registration date information elements; and delete, from the authentication keys, an authentication key with a predetermined time elapsed since the authentication key is registered.

5. The information processing system according to claim 1,
wherein in authenticating the application using the service by an authentication destination for the application, the authenticating being performed by verifying that an authentication key that is transmitted when the application uses the service and that is one of a pair of keys is paired with a held different one of the pair of keys, and
wherein the processor is configured to: verify validity of the pair of keys by transmitting an authentication key to be deleted to the authentication destination before the authentication key to be deleted is deleted.

6. The information processing system according to claim 5,
wherein the processor is configured to: in response to verifying that the pair of keys are valid, hold the authentication key to be deleted without deleting the authentication key to be deleted.

7. The information processing system according to claim 5,
wherein the processor is configured to: in response to verifying that the pair of keys are not valid, delete the authentication key determined as deletable.

8. A non-transitory computer readable medium storing a program causing a computer to execute a process comprising:
in referring to pieces of key management information each including an authentication key and an application, the authentication key being included in authentication keys that are used for authentication by applications including the application that are installed in an information processing apparatus, each of the authentication keys being used when a corresponding one of the applications uses a service and being associated with the application using the authentication key, in response to presence of an authentication key of the authentication keys that is no longer associated with any one of the applications because an application of the applications that is associated with the authentication key is uninstalled from the information processing apparatus, deleting the authentication key.

9. An information processing method comprising:
in referring to pieces of key management information each including an authentication key and an application, the authentication key being included in authentication keys that are used for authentication by applications including the application that are installed in an information processing apparatus, each of the authentication keys being used when a corresponding one of the applications uses a service and being associated with the application using the authentication key, in response to presence of an authentication key of the authentication keys that is no longer associated with any one of the applications because an application of the applications that is associated with the authentication key is uninstalled from the information processing apparatus, deleting the authentication key.
